(19) United States
(12) Patent Application Publication
(10) Pub. No.: US 2008/0238787 A1
(43) Pub. Date: Oct. 2, 2008

(54) FOLDABLE ELECTRONIC DEVICE

(75) Inventors: Sheng-Chin Lin, Taipei (TW); Yi-Wei Tseng, Taipei (TW); Tsung-Wen Chiu, Taipei (TW); Fu-Ren Hsiao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANCED CONNECTEK INC., Taipei (TW)

(21) Appl. No.: 12/056,275

(22) Filed: Mar. 27, 2008

(30) Foreign Application Priority Data
Mar. 30, 2007 (TW) 96111291

(51) Int. Cl. H01Q 1/24

(52) U.S. Cl. 343/702

(57) ABSTRACT

A foldable electronic device comprising a first body, a second body, a second body, a pivot, an antenna module, and a coupling module is provided. The first body comprises a first cover. The second body comprises a second cover. The pivot allows the second body to rotate relative to the first body. The antenna module is disposed within the first body and comprises a ground plane electrically connected to the first cover. The coupling module comprises a first coupling portion and a second coupling portion. The first coupling portion is disposed within the first body and electrically connected to the first cover. The first coupling portion is adjacent to the antenna module, and a gap formed between the antenna module and the first coupling portion. The second coupling portion disposed within the second body is electrically connected to the second cover and corresponds to the first coupling portion.

### CROSS-REFERENCE TO RELATED APPLICATION

This application claims the priority benefit of Taiwan application serial no. 96111291, filed on Mar. 30, 2007. The entirety the above-mentioned patent application is hereby incorporated by reference herein and made a part of specification.

### BACKGROUND OF THE INVENTION

1. Field of the Invention

The present invention generally relates to a foldable electronic device, and more particularly, to a coupling module integrated into a foldable electronic device with an antenna module.

2. Description of Related Art

Wireless communication products have become an important part in modern people's daily life, such as notebook computers, mobile phones, public communication devices, car navigation systems and so on. The above-mentioned devices all need to use wireless communication technology for communication, and radio signals are emitted and received by antennas and electromagnetic energy between free space and the navigation system is coupled through the antenna. In the above description, the factor affecting the signal intensity of the antenna is the antenna gain. Accordingly, the solution as to how the antenna within the electronic device may be arranged to enhance the transmission efficiency of radio signals is highly desired in this industry.

FIG. 1 is a perspective view showing a conventional antenna applied to a notebook computer. Referring to FIG. 1, the notebook computer comprises a cover 11, a display panel 12, a user interface 13, a hinge 14, a bottom plate 111, and an antenna module 113. The surface of the cover 11 is used for carrying the display panel 12, and the cover 11 is connected to the user interface 13 through the hinge 14. The bottom plate 111 made of metal is embedded inside the cover 11, and the antenna module 113 is disposed at the periphery of the bottom plate 111 for emitting and receiving radio signals. This design is to dispose the antenna module 113 at the periphery of the interior of the cover 11 and minimizes the space of the antenna module 113.

FIG. 2 is a radiation pattern of the conventional antenna at 2.45 GHz during operation. Measurement of an antenna radiation pattern is performed by measuring a radiation energy of each angle between the cover 11 and a horizontal plane of the user interface 13 when the cover 11 is open and has an included angle with the user interface 13 around 90°. The radiation energy is an antenna gain. The measured average antenna gain is about −6.6 dBi. Since the antenna module 113 disposed at the periphery of the interior of the cover 11 is very close to the user interface 13, and the user interface 13 is an object having a specific volume and comprising metallic devices, this arrangement may interfere with the radiation signals of the antenna and thereby making the range S1 of the radiation pattern has more nulls. Accordingly, the antenna gain and the signal strength of the antenna is reduced, and thus influencing the transmission efficiency of the radio wave.

### SUMMARY OF THE INVENTION

Accordingly, the present invention is directed to a foldable electronic device with an antenna module for transmitting and receiving radio wave.

As embodied and broadly described herein, the present invention provides a foldable electronic device comprising a first body, a second body, a second body, a pivot, an antenna module, and a coupling module. The first body comprises a first cover. The second body comprises a second cover. The pivot allows the second body to rotate relative to the first body. The antenna module is disposed within the first body and adjacent to the pivot, wherein the antenna module comprises a ground plane electrically connected to the first cover. The coupling module comprises a first coupling portion and a second coupling portion. The first coupling portion is disposed within the first body and electrically connected to the first cover. The first coupling portion is adjacent to the antenna module, and a gap formed between the antenna module and the first coupling portion. The second coupling portion is disposed within the second body and electrically connected to the second cover. Besides, the second coupling portion corresponds to the first coupling portion.

According to an embodiment of the present invention, the ground plane of the antenna module is electrically connected to the first cover via a metallic foil.

According to an embodiment of the present invention, the first coupling portion is a metallic foil.

According to an embodiment of the present invention, the second coupling portion is a metallic foil.

According to an embodiment of the present invention, the first coupling portion is electrically connected to a conductive portion of the first cover.

According to an embodiment of the present invention, the second coupling portion is electrically connected to a conductive portion of the second cover.

In summary, the present invention utilizes the coupling module having the first coupling portion within the first body and the second coupling portion within the second body so as to generate energy coupling effect between the first body and the second body. Therefore, it is considered that the first cover and the second cover are coupled to the ground plane of the antenna module. This arrangement may increase the radiation area of the antenna module and reduce the interference with the radiation signal caused by the metallic portion of the second body. Further, the antenna may have a better radiation pattern, the operation frequency and radiation efficiency of the antenna is increased, and the transmission efficiency of the radio wave is enhanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view showing a conventional antenna applied to a notebook computer.

FIG. 2 is a radiation pattern of the conventional antenna at 2.45 GHz during operation.

FIG. 3 is a perspective view showing a foldable electronic device according to an embodiment of the present invention.

FIG. 4 is a partially enlarged view showing the antenna module and the coupling module of the foldable electronic device as shown in FIG. 3.

FIG. 5 is a radiation pattern of the foldable electronic device having the coupling module at 2.45 GHz during operation.

FIG. 6 is a diagram showing the voltage standing wave ratio (VSWR) of the antenna according to an embodiment of the present invention.

FIG. 7 is a perspective view showing the coupling module shown in FIG. 4 applied to a mobile phone.

FIG. 8a is a radiation pattern of the mobile phone without the coupling module.

FIG. 8b is a radiation pattern of the mobile phone with the coupling module.

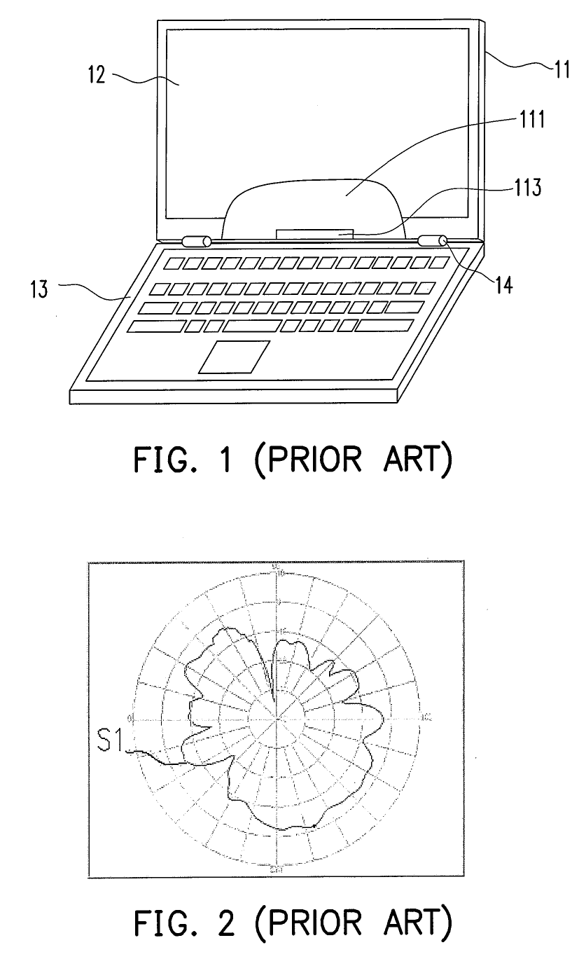

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

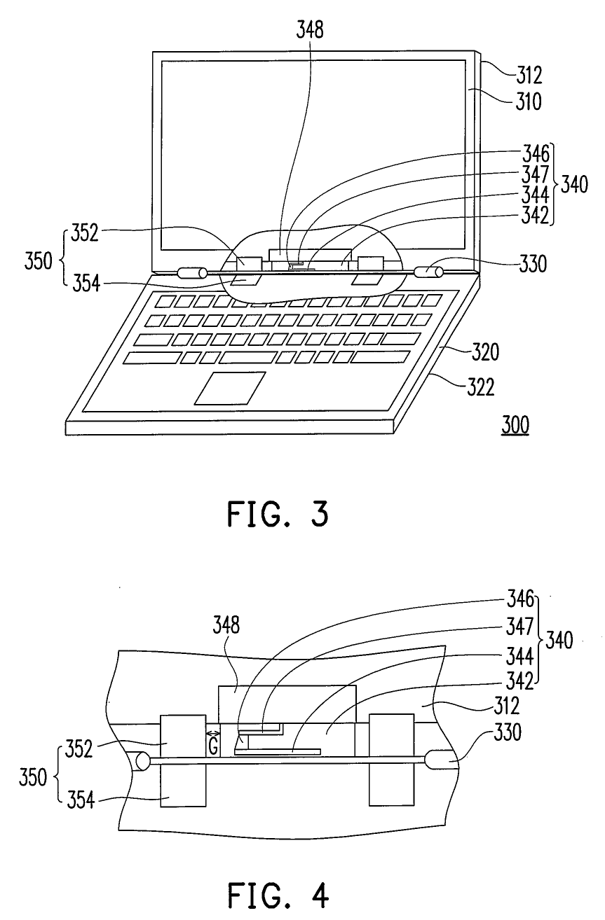

FIG. 3 is a perspective view showing a foldable electronic device according to an embodiment of the present invention. FIG. 4 is a partially enlarged view showing the antenna module and the coupling module of the foldable electronic device as shown in FIG. 3. The present invention utilizes a coupling module arranged adjacent to an antenna module of the foldable electronic device for increasing the operation frequency and radiation efficiency of the antenna, and thus the transmission efficiency of the radio wave is enhanced. The elements of the foldable electronic device 300 and the connection relationships between the elements are illustrated with reference to the drawings below.

Referring to FIG. 3, the foldable electronic device 300 comprises a first body 310, a second body 320, a pivot 330, an antenna module 340, and a coupling module 350. In this embodiment, a notebook computer is taken as an example for illustration. Therefore, the first body 310 is a display module, and the second body 320 is a mainframe of the notebook computer. However, the coupling module may also be applied to other kinds of foldable electronic device, and the type of the foldable electronic device is not limited in the present invention. As shown in FIG. 3, the first body 310 has a first cover 312, and the second body 320 has a second cover 322 for protecting the notebook computer 300 from being damaged. The pivot 330 allows the second body 320 to rotate relative to the first body 310.

Referring to FIG. 3 and FIG. 4, the antenna module 340 is disposed within the first body 310 and adjacent to the pivot 330 for transmitting and receiving radio wave. The antenna module 340 comprises a substrate 342, a first radiation body 344, a short-circuit portion 346, and a ground radiation portion 347. The first radiation body 344, the short-circuit portion 346, and the ground radiation portion 347 are formed on the substrate 342. A ground plane 348 composed of a metallic foil is connected to the ground radiation portion 347. More specifically, the ground plane 348 is also electrically connected to a conductive portion (not shown) of the first cover 312.

The coupling module 350 comprises a first coupling portion 352 and a second coupling portion 354. The first coupling portion 352 is disposed within the first body 310 and electrically connected to the first cover 312 of the first body 310. As shown in FIG. 4, the first coupling portion 352 is disposed adjacent to the antenna module 340, and a gap G formed between the antenna module 340 and the first coupling portion 352. More specifically, the first coupling portion 352 is a metallic foil partially attached to a conductive portion of the first cover 312. Similarly, the second coupling portion 354 is disposed within the second body 320 and electrically connected to the second cover 322 of the second body 312. As shown in FIG. 4, the second coupling portion 354 corresponds to the first coupling portion 352. Specifically, the second coupling portion 354 is a metallic foil partially attached to a conductive portion of the second cover 322.

The present invention utilizes the coupling module 350 composed of the first coupling portion 352 and the second coupling portion 354 to generate signal coupling effect between the first cover 312 and the second cover 322. The first cover 312 is made of metal, and the ground radiation portion 347 is electrically connected to the first cover 312. Accordingly, the first cover 312 serves as a ground. Besides, the energy coupling effect formed between the second cover 322 and the first cover 312 through the coupling module 350 can be considered as electrical connection, therefore, the second cover 322 is deemed to be electrically connected to the ground radiation portion 347 of the antenna module 340. Accordingly, the second cover 322 also serves as a ground. This arrangement may increase the radiation area of the antenna module 340 and reduce the interference with the radiation signal caused by the metallic parts of the second cover 322. Further, the antenna may have a better radiation pattern, the operation frequency and radiation efficiency of the antenna is increased, and the transmission efficiency of the radio wave is enhanced.

The dimensions of the components of the antenna module 340 are designed as following for achieving better transmission efficiency. The first radiation body 344 has a length about 26 mm and a width about 1 mm. The length of the short-circuit portion 346 is about 2.5 mm. The ground radiation portion 347 has a length about 12 mm and a width about 1 mm. The ground radiation portion 347 is also connected to a metallic foil to form the ground plane 348 with a length about 40 mm and a width about 40 mm. The first coupling portion 352 having a length about 30 mm and a width about 10 mm is neighboring to the antenna module 640, and the gap between the first coupling portion 352 and the antenna module 340 is smaller than 30 mm. The second coupling portion 354 is disposed on the periphery of the second cover 322, and a gap formed between the first coupling portion 352 and the second coupling portion 354. The second coupling portion 354 has a length about 20 mm and a width about 10 mm. The gap between the second coupling portion 354 and the first coupling portion 352 is controlled under 10 mm for enhancing the coupling strength of the coupling module 350.

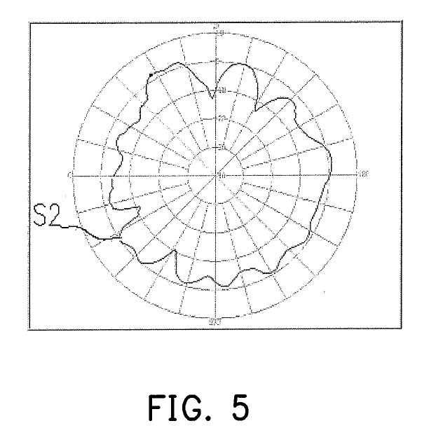

FIG. 5 is a radiation pattern of the foldable electronic device having the coupling module at 2.45 GHz during operation. Measurement of an antenna-radiation pattern is performed by measuring a radiation energy of each angle between the first cover 312 and a horizontal plane of the second cover 322 when the first cover 312 is open and has an included angle with the second cover 322 around 90°. The radiation energy is an antenna gain. From the measured data, the measured average antenna gain is about −2.2 dBi, and it is effectively enhanced as compared with the conventional antenna having the average antenna gain of −6.6 dBi. It is shown that the interference with the radiation pattern of the antenna is reduced due to the arrangement of the coupling module 350, and the range S2 of the radiation pattern tends to an omni-directional radiation pattern. Similarly, the radiation pattern of the antenna remains the same when the antenna operates at other operation frequency due to the same arrangement.

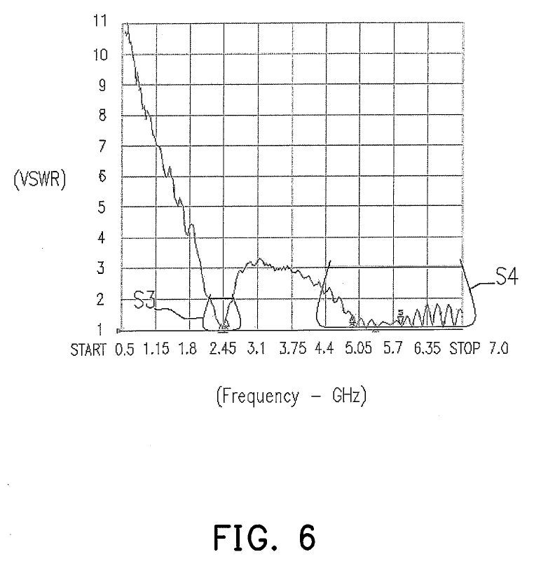

FIG. 6 is a diagram showing the voltage standing wave ratio (VSWR) of the antenna according to an embodiment of the present invention. This diagram shows the change of the VSWR curve of the antenna at frequency S3 (frequency range between 2.4-2.5 GHz) and frequency S4 (frequency range between 4.9-5.825 GHz). In the conventional standard specification, VSWR of each kind of antennas must be smaller than 3 for satisfying different requirements of antennas. From this diagram, the whole frequency band of the antenna is smaller than 3, and most of the frequency band is smaller than 2. Accordingly, the operation bandwidth of the antenna is effectively improved.

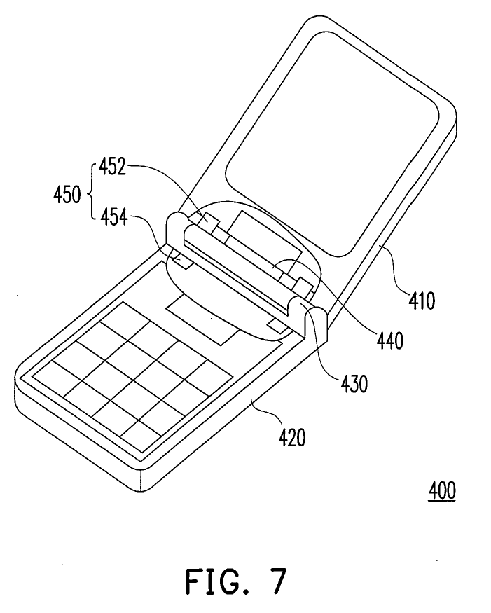

FIG. 7 is a perspective view showing the coupling module shown in FIG. 4 applied to a mobile phone. Referring to FIG. 7, the mobile phone 400 comprises a first body 410, a second body 420, a pivot 430, an antenna module 440, and a coupling module 450. The coupling module 450 is also neighboring to the antenna module 440. When the side edge of the second body 420 on which the first body 410 of the mobile phone 400 is pivoted is shorter, one of the first coupling portion 452 and the second coupling portion 454 may be arranged on the surface of the pivot 430 for enhancing the flexibility of arranging the coupling module 350 within the mobile phone 400.

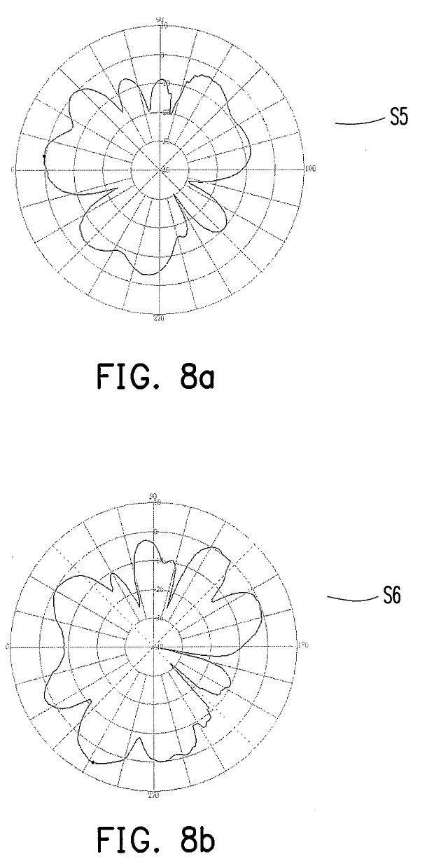

FIG. 8a is a radiation pattern of the mobile phone without the coupling module. FIG. 8b is a radiation pattern of the mobile phone with the coupling module. Since the same coupling module is used in the mobile phone, the radiation pattern is not changed at different operation frequency. Therefore, a radiation pattern of the antenna at 2.45 GHz during operation is taken as an example for illustration. Measurement of an antenna radiation pattern is performed by measuring a radiation energy of each angle between the first body 410 and a horizontal plane of the second body 420 when the first body 410 is open and has an included angle with the second body 420 around 90°. The radiation energy is an antenna gain. As shown in FIG. 8a, the antenna radiation pattern S5 has more nulls without using the coupling module 350 of the present invention. As shown in FIG. 8b, the interference with the antenna radiation pattern is reduced after using the coupling module 450, and the average antenna gain increases from −6.10 dBi before using the coupling module to −2.70 dBi, such that the radiation pattern S6 tends to an omni-directional radiation pattern.

The present invention utilizes the coupling module to generate signal coupling between the first body and the second body of the foldable electronic device, and thus the first cover of the first body and the second cover of the second body may serve as a ground respectively. Therefore, the interference with the radiated signal is reduced, and the antenna module has a better radiation pattern. Meanwhile, the arrangement of the first coupling portion and the second coupling portion is flexible according to the volume of the electronic device. This may enhance the flexibility of arranging the related parts within the electronic device, such that the coupling module may be applied to electronic devices having different sizes.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A foldable electronic device, comprising:
a first body having a first cover;
a second body having a second cover;
a pivot allowing the second body to rotate relative to the first body;
an antenna module disposed within the first body and adjacent to the pivot, the antenna module having a ground plane electrically connected to the first cover; and
a coupling module having:
a first coupling portion disposed within the first body and electrically connected to the first cover, the first coupling portion arranged adjacent to the antenna module, and a gap formed between the antenna module and the first coupling portion; and
a second coupling portion disposed within the second body and electrically connected to the second cover, and corresponding to the first coupling portion.

2. The foldable electronic device according to claim 1, wherein the ground plane of the antenna module is electrically connected to the first cover via a metallic foil.

3. The foldable electronic device according to claim 1, wherein the first coupling portion is a metallic foil.

4. The foldable electronic device according to claim 1, wherein the second coupling portion is a metallic foil.

5. The foldable electronic device according to claim 1, wherein the first coupling portion is electrically connected to a conductive portion of the first cover.

6. The foldable electronic device according to claim 1, wherein the second coupling portion is electrically connected to a conductive portion of the second cover.
